(19) United States
(12) Patent Application Publication
(10) Pub. No.: US 2018/0335395 A1
(43) Pub. Date: Nov. 22, 2018

(54) SYSTEM FOR ASSESSING BRIDGE DECK CONDITION AND RELATED METHODS

(71) Applicant: INFRASTRUCTURE PRESERVATION CORPORATION, Clearwater, FL (US)

(72) Inventor: William Seavey, Clearwater, FL (US)

(21) Appl. No.: 15/985,166

(22) Filed: May 21, 2018

Related U.S. Application Data
(60) Provisional application No. 62/508,817, filed on May 19, 2017.

(51) Int. Cl. G01N 22/02; G01S 13/88; G01S 13/89; G01S 13/86; G06Q 10/00

(52) U.S. Cl. CPC G01N 22/02; G01S 13/885; G06Q 10/20; G01S 13/867; G01S 13/89

(57) ABSTRACT

A system to assess bridge deck conditions includes a sensing device configured to generate cross sectional sensing data of a bridge deck, and a positioning device configured to determine a geographic position of the sensor device relative to the bridge deck. The system also includes a memory coupled to the sensing device and the positioning device, where the memory is configured to store the sensing data and the geographic positioning data. In addition, a processor is coupled to the memory, where the processor is configured to generate imagery of the sensing data for display, detect at least one area of interest from the imagery that exceeds a threshold value, and generate a plan of action to repair the at least one area of interest from the imagery that exceeds a threshold value.

The present invention is related to U.S. Provisional Patent Application Ser. No. 62/508,817 filed May 19, 2017, the entire contents of which are incorporated herein by reference.

### TECHNICAL FIELD

The present invention relates to the field of bridge inspections, and, more particularly, to a system for assessing bridge deck condition and related methods.

### BACKGROUND

Many bridges in the United States are known to have deficiencies. It is often difficult to determine which of these bridges need the greatest attention and how best to allocate resources for repair. Existing bridge inspection techniques are used to rate individual bridges according to their deficiencies. The most commonly utilized assessment methods include visual inspections performed by engineers in accordance with National Bridge Inventory scoring practices. However, the existing assessment methods are lacking in providing an objective quantification of the deterioration of a bridge deck and other elements.

In particular, bridge decks are an important part of any individual bridge system because their condition state and maintenance often affects underlying structure. The bridge decks protects the bridge superstructure from the elements and are the part of the bridge that the public travels over. Deck repairs can be a significant portion of repair costs of bridges over their lifetime.

Scores based on subjective visual inspection scores of the bridge deck, underside, and substructures currently provide the criteria for making bridge deck management decisions. However, visual inspections do not provide objective, quantitative decision-making criteria which enable uniform standards to be used for resource allocation. Instead, the inspectors are providing subjective conclusions based on their visual interpretations and which are not always repeatable from different inspectors. In addition, visual inspections do not directly assess the internal condition of the reinforced concrete components of the bridge deck.

Visual inspections may identify where surface defects are manifesting but internal deterioration may not reveal any surface signs for years until after significant internal damage is already done. This will require more expensive repairs than if the internal deterioration was identified earlier and addressed.

However, in view of the prior art at the time the present invention was made, it was not obvious to those of ordinary skill in the pertinent art how the identified needs could be fulfilled. Accordingly, there is a need for a system and method to assess bridge deck conditions over time that is objective and can prioritize those bridges that are in most need of repair.

### SUMMARY

In a particular embodiment, a system to assess bridge deck conditions is disclosed. The system includes a sensing device configured to generate cross sectional sensing data of a bridge deck, and a positioning device configured to determine a geographic position of the sensor device relative to the bridge deck. The system also includes a memory coupled to the sensing device and the positioning device, where the memory is configured to store the sensing data and the geographic positioning data. In addition, a processor is coupled to the memory, where the processor is configured to generate imagery of the sensing data for display, detect at least one area of interest from the imagery that exceeds a threshold value, and generate a plan of action to repair the at least one area of interest from the imagery that exceeds a threshold value.

### BRIEF DESCRIPTION OF THE DRAWINGS

FIG. 1 is a plan view of a concrete bridge over water;

FIG. 2 is a cross sectional view of a typical concrete bridge;

FIG. 3 is a plan view of an approach of the bridge shown in FIG. 2;

FIG. 4 is an image of the approach shown in FIG. 3 generated from ground penetrating radar (GPR);

FIG. 5 is a chart used for assigning deterioration levels for a bridge;

FIG. 6 is a three dimensional (3D) image of a concrete slab of the bridge approach shown in FIG. 4;

FIG. 7 is an image of a bridge deck of the bridge approach shown in FIG. 4;

FIG. 8 is a plan view of the concrete bridge of FIG. 1 aligned with an image generated from GPR shown in FIG. 9;

FIG. 9 is an image generated from GPR and aligned with the plan view of the concrete bridge shown in FIG. 8;

FIG. 10 is a picture of an inspector performing an inspection using GPR;

FIG. 11 is a 3D image of a location where a core sample was taken during the inspection;

FIG. 12 is an enhanced 3D image showing upper reinforcing mat relative to the core sample;

FIG. 13 is an enhanced 3D image showing the lower reinforcing mat relative to the core sample;

FIG. 14 is an image showing a rebar pattern indicating no evidence of deterioration or delamination at the upper reinforcing mat of FIG. 12; and

FIG. 15 is a chart used for determining a plan of action to address deterioration levels of a bridge.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The system for assessing bridge deck condition is a comprehensive assessment that provides more detailed condition information than traditional inspection methods. In particular, the system locates delamination, maps rebar placement, conducts approach slab deterioration assessment, locates voids under approach slab, provides fill density assessment under approach slabs, provides abutment water intrusion assessment, and assigns a level of deterioration.

The system utilizes the Non-Destructive Testing (NDT) technologies to locate and quantify concrete deterioration, delamination and debonding, to identify rebar patterns and sizing, locate and monitor crack progression and produce condition assessment reports. This is in contrast to existing assessment systems because bridge structures are traditionally inspected visually for cracks and damage due to deterioration.

Through such traditional practices, bridge inspectors visually inspect a bridge, record cracks and damage, take pictures and give the bridge a health rating. A shortcoming of the prior assessment systems and methods is that visual inspections cannot assess the internal integrity of these structures, but only what is visible to the naked eye.

By the time deterioration becomes visually apparent to the inspector, the damage to the structure is often severe. Deterioration within a bridge is similar to a progressive disease. If caught early, the deterioration can be more cost-effectively repaired, thereby extending the service life of the structure. The present system to assess bridge condition provides valuable information to bridge owners and engineers performing load rating analysis by identifying locations and degrees of concrete deterioration as well as rebar placement patterns and sizing. This information is used to generate Condition Assessment Ratings and Remaining Life Estimates. Bridge owners use the Condition Assessment Reports generated by the system in order to budget maintenance and prolong a structure's life expectancy through early detection and repair of deterioration.

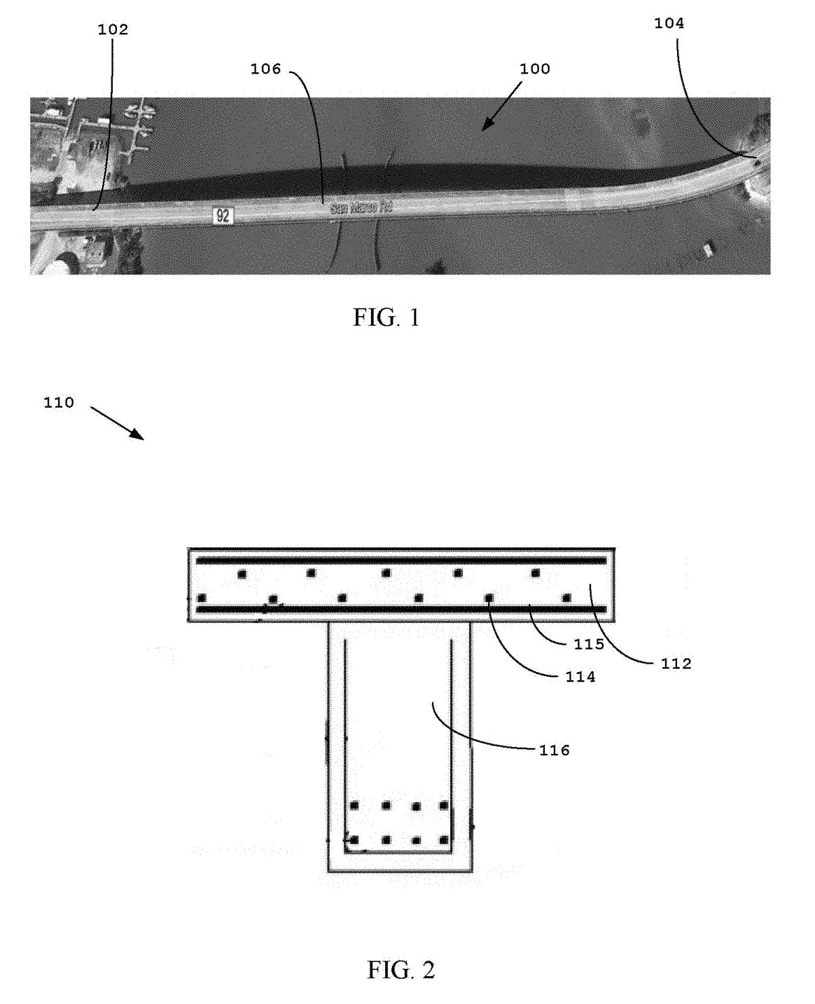

Referring now to FIG. 1, a typical concrete bridge 100 is shown. The bridge 100 includes an approach at each end 102, 104, and a center span 106 therebetween. In this particular example, the center span 106 is over a waterway. However, the system and method described herein are applicable to all concrete bridges over waterways or over land or other structures.

A cross sectional view of the typical concrete bridge 100 is shown in FIG. 2. The system is able to look inside a bridge's concrete deck 110 and analyze the deck's steel reinforcement. The strength of a deck is determined by the pattern and size of its rebar. The structure of the bridge deck 110 includes a reinforced concrete bridge slab 112. The bridge slab 112 may have a plurality of longitudinal 114 and traverse rebars 115. There may also be more than one layer of rebars 114 as shown in FIG. 2.

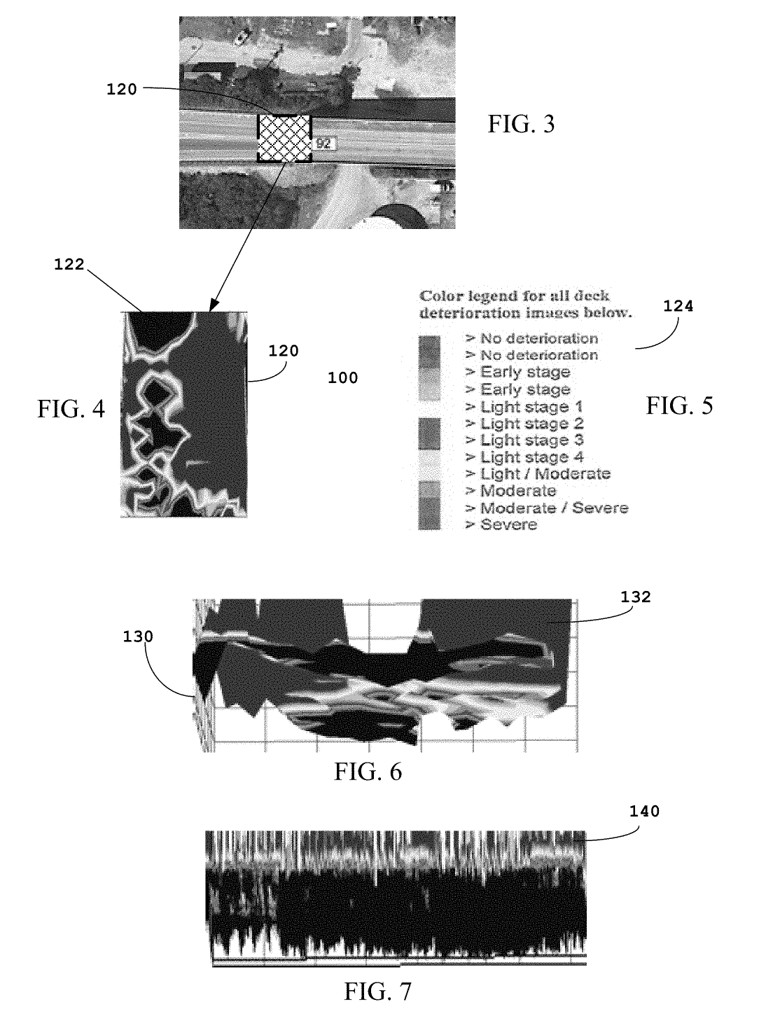

FIG. 3 is illustrating an approach area 120 of the bridge 100 shown in FIG. 1 that is being inspected for condition. FIG. 4 is an image 122 of the approach 120 shown in FIG. 3 generated from ground penetrating radar (GPR). The GPR is configured to generate a radar signal and measure radar return signal attenuation of at least the top surface of a rebar mat of the bridge deck 110.

The image 122 represents sensing data of the approach 120 and indicates different areas on the approach 120 that correspond to increased deterioration. FIG. 5 is a chart used for assigning deterioration levels for a bridge according to the different color/shaded areas generated from the sensing data and displayed on the image 122.

Referring now to FIG. 6, a 3D image is illustrating a deterioration depth analysis indicating severe deterioration of the bridge deck 110. In contrast, FIG. 7 is a 3D image showing a good section of the bridge deck 110.

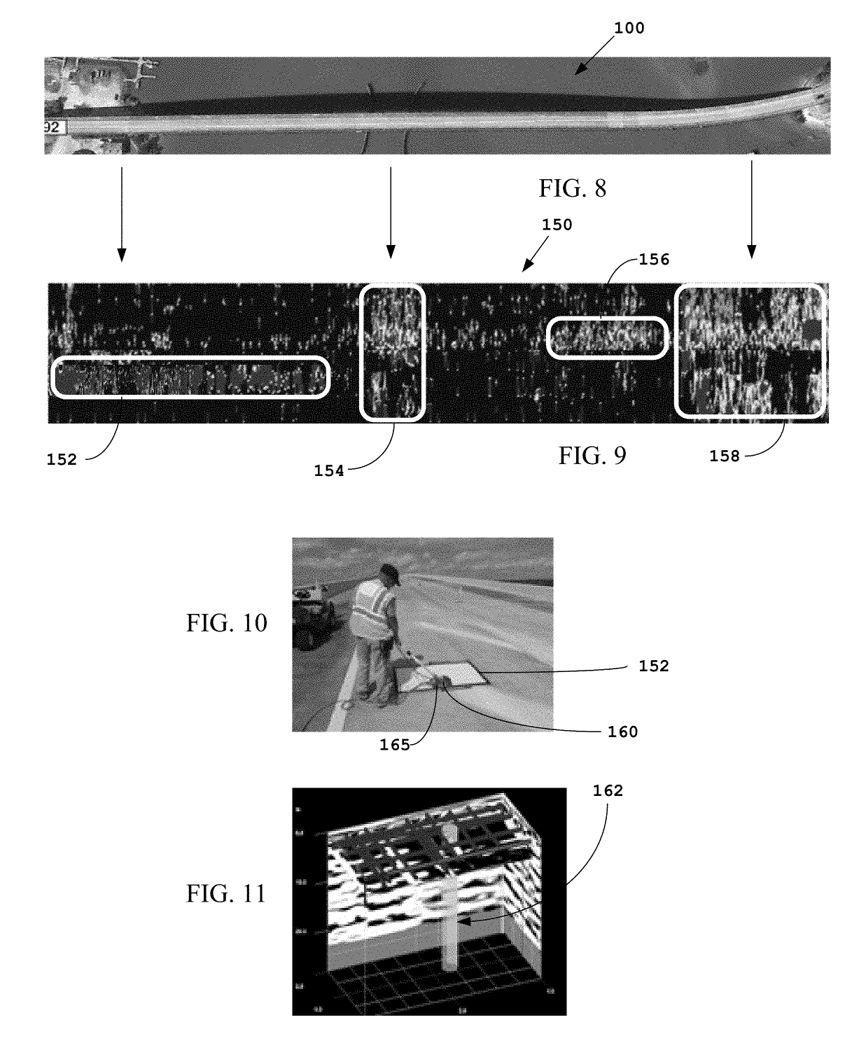

The entire length of the bridge 100 is shown in FIG. 8. An image generated from GPR sensing data is shown in FIG. 9 and aligned with the plan view of the bridge 100 shown in FIG. 8. The overall condition of the bridge 100 shown in the image indicates light to moderate deterioration in the areas of interest 152, 154, 156, 158, indicated by the highlighted boxes.

A particular area of interest 152 of the bridge deck 112 can also be tested by an inspector as shown in FIG. 10 using a sensing device 160 such as GPR. In addition, a painting device 165 may be coupled to the sensing device 160 that is configured to automatically activate and mark the area of interest on the bridge deck with paint in a color that correlates with a detected deterioration level of the bridge deck. Thus, the area of interest can be easily located on the bridge deck for future reference.

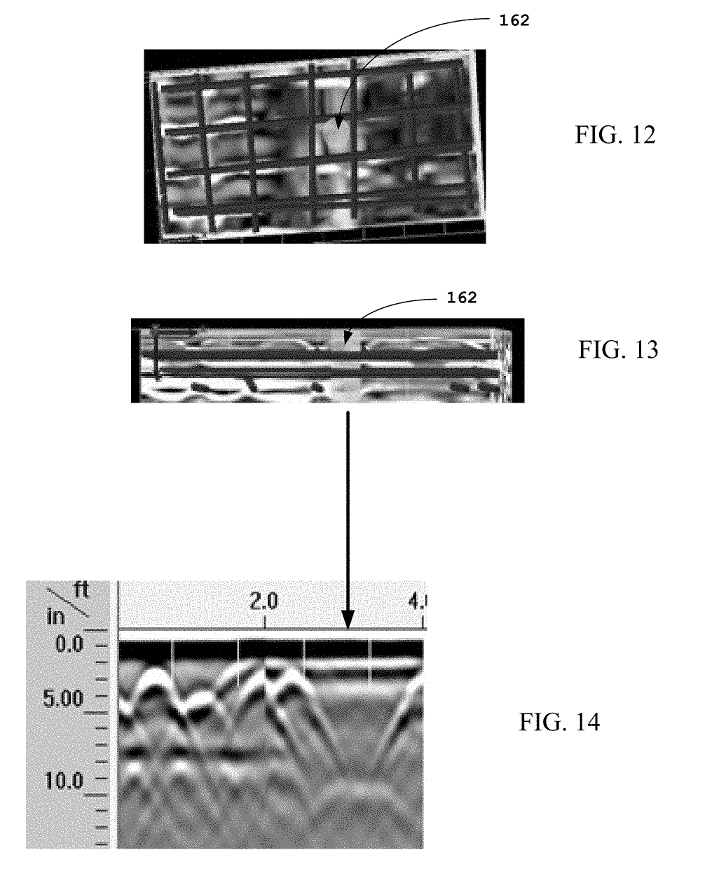

FIG. 11 is a 3D image of the area of interest 152 where a core sample 162 was taken during an inspection. FIG. 12 is an enhanced 3D image showing an upper rebar mat relative to the core sample 162. FIG. 13 is an enhanced 3D image showing the lower rebar mat relative to the core sample 162, and FIG. 14 is an image showing a rebar pattern indicating no evidence of deterioration or delamination at the upper rebar mat of FIG. 12.

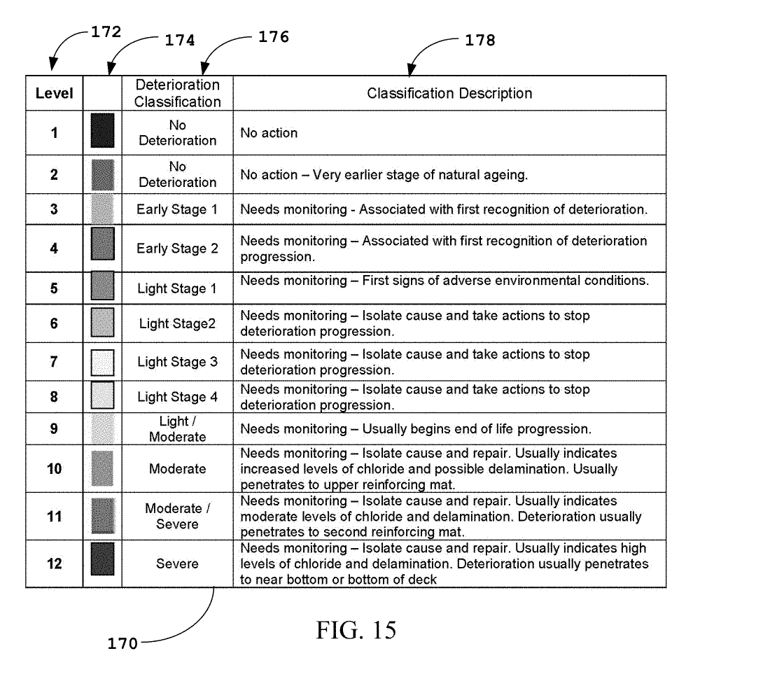

Referring now to FIG. 15, a chart 170 is shown that is used to determine a plan of action to address deterioration levels of a bridge that were detected during the inspection. The deterioration of the bridge 100 may also be analyzed in order to determine additional assessment and/or maintenance priorities for bridges within a network.

For example, numerical values are provided in the first column 172 that correlate with various condition levels of the bridge. The second column 174 includes a color indicator that correlates to the condition level in column 172. Continuing to move to the right in the chart 170, the third column 176 provides a written description for the condition level going from “no deterioration” at level “1” to “severe” at level “12”. Moving to the fourth column 178, a plan of action is provided for each deterioration classification. For example, if the bridge deck condition is determined to be condition level 10, moderate deterioration, then the action item is “needs monitoring—isolate cause and repair. Usually indicates increased levels of chloride and possible delamination. Usually penetrates to upper reinforcing (rebar) mat.” Accordingly, the system not only detects the deterioration of the bridge deck and assigns a condition level, the system also provides actionable items to the bridge owner that it can take to extend the life of the bridge.

The system for the assessment of bridge deck conditions includes a processor coupled to a memory, which may be contained in the sensing device 160. The processor is coupled to the GPR or other sensing device used to obtain sensing data, which is a representation of the interior of the bridge deck 110. The GPR may also be used with additional devices such as thermal imagery cameras, moisture sensors, temperature sensors, etc. The sensing device 160 may be moved by the inspector as shown in FIG. 10 or the sensing device 160 may be carried by a vehicle at highway speeds to obtain the sensing data used to generate the imagery. The sensing data from the sensing device 160 may be stored in the memory.

The sensing device 160 may also include a GPS sensor that can determine the location of the sensor device 160 when scanning and store the locations in the memory. The memory can be a computer readable medium encoded with a computer program, software, computer executable instructions, instructions capable of being executed by a computer, etc., such as by processor. The memory may include a database to store the sensing data, the location data, the time stamp data, and any other relevant data.

The memory may include computer readable medium encoded with a computer program. Execution of the computer program by the processor causes the processor to generate the scanning imagery from the sensing data and to generate a plan of action for a particular area of interest where deterioration was detected such as that shown in FIG. 15. The processor is configured to compare the current plan of action with a prior recorded plan of action for a same area of interest. The processor is further configured to generate a new plan of action when the prior recorded plan of action that was implemented and the current plan of action indicates no improvement in the area of interest.

The system may also include a user interface and a display that may be used to enable an inspector to reference a particular bridge's deck data, deterioration data, and history. According to some embodiments of the present invention the system includes a remote server. The remote server may be used to enable a plurality of inspectors in different locations to access the data base. The database may be coupled to a server which allows access to the database by multiple users. Multiple users may have access to the sensing data for the bridges using a smartphone, for example, that can be accessed in the field wherever a cellular connection can be established. For example, the server may be configured to implement a web-based application that facilitates multiple user access via the Internet. The database may also include priority and resource allocation data that can be accessed remotely. Bridge maintenance schedules and status of repair data may be incorporated and updated periodically to provide real-time status of bridge inspections and maintenance/repairs.

A method for assessing bridge deck conditions includes scanning a bridge deck to obtain sensing data. The method also includes generating scanning imagery from the sensing data to display, and identifying areas of deterioration of the bridge deck. In addition, the method includes assigning deterioration levels for at least one area of interest of bridge, and determining an action item to address the at least one area of interest and a priority level.

The present system and method is directed to an objective process to assess bridge deck conditions and to provide a plan of action. The objective process offers more accurate assessments, which results in cost-savings for bridge owners and managers by better prioritizing their resource allocation decisions and allowing for more effective and successful future planning.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system to assess bridge deck conditions, the system comprising:
a sensing device configured to generate cross sectional sensing data of a bridge deck;
a positioning device configured to determine a geographic position of the sensing device relative to the bridge deck;
a memory coupled to the sensing device and the positioning device configured to store the sensing data and the geographic positioning data; and
a processor coupled to the memory, the processor configured to
generate imagery of the sensing data for display,
detect an area of interest from the imagery that exceeds a threshold value, and
generate a current plan of action to repair the area of interest from the imagery that exceeds a threshold value.

2. The system of claim 1, wherein the processor is further configured to record in the memory the current plan of action associated with the area of interest.

3. The system of claim 2, wherein the processor is further configured to compare the current plan of action with a prior recorded plan of action for a same area of interest.

4. The system of claim 3, wherein the processor is further configured to generate a new plan of action when the prior recorded plan of action that was implemented and the current plan of action indicates no improvement in the area of interest.

5. The system of claim 4, wherein the processor is further configured to generate the plan of action to visually indicate defects of the bridge.

6. The system of claim 1, wherein the sensing device comprises ground penetrating radar (GPR).

7. The system of claim 1, further comprising a painting device coupled to the sensing device that is configured to automatically activate and mark the area of interest on the bridge deck with paint in a color that correlates with a detected deterioration level of the bridge deck.

8. The system of claim 1, further comprising an antenna configured to wirelessly transmit the current plan of action to a receiver associated with a bridge owner.

9. The system of claim 1, wherein the processor is further configured to correlate an assigned condition level with a particular action item.

10. The system of claim 1, wherein the sensing device is mounted to a vehicle and configured to operate at highway speeds to obtain the sensing data used to generate the imagery.

11. The system of claim 1, further comprising a thermal imagery camera coupled to the sensing device and configured to detect moisture levels of the bridge deck that indicate deterioration.

12. The system of claim 1, wherein the processor is further configured to generate a visual indicator on an image of the bridge deck and configured to indicate the location of the area of interest and condition of the bridge deck.

13. The system of claim 1, wherein the processor is further configured to generate a three dimensional image of a section of the bridge deck using the sensing data.

14. The system of claim 1, wherein the processor is further configured to determine the rebar placement patterns and sizing of the bridge deck using the sensing data.

15. A system to assess bridge deck conditions, the system comprising:
a ground penetrating radar (GPR) sensing device configured to generate cross sectional sensing data of a bridge deck;
a memory coupled to the sensing device and configured to store the sensing data;
a processor coupled to the memory; and
a painting device coupled to the processor that is configured to automatically activate and mark an area of interest on the bridge deck with paint in a color that correlates with a detected deterioration level of the bridge deck.

16. The system of claim 15, wherein the processor is further configured to detect an area of interest from the sensing data that exceeds a threshold value.

17. The system of claim 16, wherein the processor is further configured to generate a new plan of action when a prior recorded plan of action and a current plan of action indicates no improvement in the area of interest.

18. The system of claim 17, wherein the processor is further configured to generate a plan of action to visually indicate defects of the bridge.

19. A method to assess bridge deck conditions, the method comprising:
scanning a bridge deck with ground penetrating radar (GPR) to capture sensing data;
recording the sensing data into a memory;
generating scanning imagery from the sensing data using a processor coupled to the memory;
identifying an area of interest of deterioration of the bridge deck from the scanning imagery using the processor; and
determining an action item to address the area of interest and a priority level using the processor.

20. The method of claim 19, further comprising activating a painting device coupled to the processor to mark the bridge deck with paint at the area of interest of deterioration when deterioration is identified.
